(19) United States
(12) Patent Application Publication
(10) Pub. No.: US 2007/0148397 A1
(43) Pub. Date: Jun. 28, 2007

(54) FLOCKED MULTI-COLORED ADHESIVE ARTICLE WITH BRIGHT LUSTERED FLOCK

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 11/565,974

(22) Filed: Dec. 1, 2006

Related U.S. Application Data
(60) Provisional application No. 60/748,505, filed on Dec. 7, 2005.

(51) Int. Cl. D03D 27/00; B05D 1/14; B32B 3/02; B32B 33/00

(52) U.S. Cl. 428/90; 428/92; 428/97

(57) ABSTRACT

A design and process are provided in which a plurality of differently colored adhesives underlie differently colored flock fibers.

### CROSS REFERENCE TO RELATED APPLICATION

The present application claims the benefits, under 35 U.S.C. §119(e), of U.S. Provisional Application Ser. No. 60/748,505, filed Dec. 7, 2005, of the same title, which is incorporated herein by this reference.

### FIELD OF THE INVENTION

The invention relates generally to flocked articles and particularly to flocked multi-colored adhesive articles.

### BACKGROUND OF THE INVENTION

Flocked articles are used in a wide variety of applications. For example, flocked articles are used as patches, transfers, molded objects, and the like. Flock is much less expensive than woven articles while providing a more plush feel.

An important aspect of the appearance of a flocked article is flock density. The adhesives of flocked articles are typically colored differently than the flock fibers themselves (with most adhesives being white) and visually unappealing and therefore must be concealed from the user by the flock fibers. To adequately conceal the adhesive from view, manufacturers have used relatively high flock densities, which has increased operating costs and impacted detrimentally the “feel” of the flocked surface.

Even with higher flock densities, the wear resistance of such flocked articles can be limited. As flock fibers are dislodged during use, the adhesive will be revealed, destroying the visual appeal of the article.

There is thus a need to provide a flocked article having a high degree of plushness and wear resistance, while using a lower flock density compared to existing articles.

### SUMMARY OF THE INVENTION

These and other needs are addressed by the various embodiments and configurations of the present invention.

In one embodiment, the invention is directed to the use of bright or semi-bright lustered flock and underlying colored adhesives to realize various visual effects in the flocked product. The colors of the flock may be the same as the color of the underlying adhesive. A transparent adhesive layer may be positioned between the flock and the colored adhesive layer to provide a “frosted” effect and adhere the flock to the colored adhesive layer.

Brilliant or bright color flock fibers normally contain little or no white pigment (titanium dioxide), which is normally used to diffuse the light to eliminate unsightly shading or mottling or shadows from light passing through the fibers. Multicolor flock products normally use a white adhesive backing that would tend to show through the fibers somewhat or influence them with light reflecting off the adhesive and passing back through the fibers. A medium blue bright fiber, for example, would appear lighter and, as one's viewing angle shifted, one could see evidence of shading, which is variation in the amount of light reflected and passing back through the fiber. With normal multicolor printing with white adhesive, this is a problem but with the present invention the backing adhesive could be blue. Color matching adhesive and flock can reduce dramatically the shading effect because the same color is reflected and transmitted back through the fibers instead of white. Moreover, to realize a desired appearance, color matching permits the use of a lower flock density when compared to color mismatching with a white adhesive.

In one embodiment, the invention is directed to the use of a setting or solidifying agent to solidify and/or gel the colored adhesives, in whole or part, between adhesive printing stations. In one configuration, the agent is located in both the adhesive and a fluid applied to the adhesive. The fluid, when contacted with the adhesive, causes the adhesive to have a translucent chemical film around the adhesive print, preferably within a substantially shorter time than is needed for the next color of adhesive in the next station to be applied. Preferably, the fluid comprises a bivalent and/or trivalent metal salt on a base of a metal from Groups IA (alkali metals), IIA (alkaline earth metals), VIIB, VIIIA, IB, IIB, and IIIB of the Periodic Table of the Elements (Previous IUPAC form), and even more preferably a metal salt of magnesium and/or calcium and/or aluminum, and the adhesive includes an alginate compound (which is a derivative of alginic acid (e.g., calcium, sodium, or potassium salts or propylene glycol alginate)). As will be appreciated, alginates are normally hydrophilic colloids (hydrocolloids) obtained from seaweed. Sodium alginate, in particular, is water-sohlble but reacts with calcium salts to form insoluble calcium alginate.

The use of a solidifying agent permits the various colors of adhesives to be applied relatively rapidly, generally without increasing significantly the incidence of clogging of the adhesive depositing stations. As will be appreciated, such clogging is normal when printing one wet adhesive in proximity to another wet adhesive.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a plan view of a flocked article according to an embodiment of the present invention;

FIG. 2 is a side view of a flocked transfer according to an embodiment of the present invention;

FIG. 3 is a side view of the flocked transfer without the carrier sheet and release adhesive;

FIG. 4 is a flow chart of a manufacturing process for the flocked transfer of FIG. 2;

FIG. 5 is a side view of a direct flocked article according to an embodiment of the present invention;

FIG. 6 is a flow chart of a manufacturing process for the direct flocked article of FIG. 5; and

FIG. 7 is a side view of a manufacturing line for the flocked articles according to an embodiment of the present invention.

### DETAILED DESCRIPTION

FIG. 1 shows a flocked article 100 according to an embodiment of the present invention. The flocked article 100 comprises two different colored regions, namely the lettered areas 104a-m have a first color and the background region 108 a second color. Both the flock and at least a portion of the underlying adhesive in the lettered areas 104a have substantially the same (first) color and that in the background region 108 substantially the same (second) color. In this way, the adhesive will “blend in” with, and visually highlight the flock.

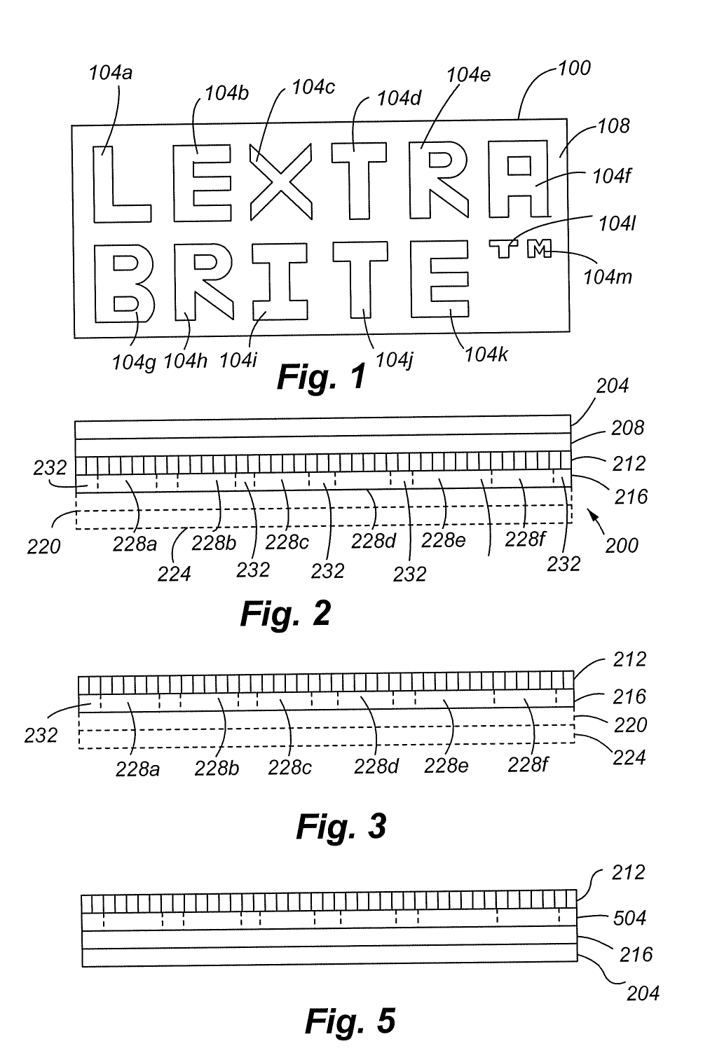

FIG. 2 shows a flocked article 200 according to an embodiment of the present invention. The article 200 includes a carrier sheet 204, release adhesive layer 208, flock layer 212, and first, second, and third adhesive layers 216, 220, and 224 (with the second and third adhesive layers 220 and 224 being optional). As can be seen from FIG. 2, the flock fibers in the flock layer 212 are substantially perpendicular to the planes of the carrier sheet 204 and adhesive layers 216, 220, and 224 to provide a plush feel. To adhere the article 200 to a desired substrate, the adhesive layer 224 is placed against the substrate (not shown) surface, and heat and pressure applied to the carrier sheet 204. The heat will melt, at least partially, the third adhesive layer 224. When the heat is removed, the third adhesive layer 224 will adhere reversibly (but permanently absent remelting) to the substrate.

The carrier sheet 204 can be any desirable sacrificial carrier, such as cellulose (paper), microporous substrate (such as described in U.S. Pat. No. 6,025,068 and copending U.S. Provisional Application Ser. Nos. 60/628,836, filed Nov. 16, 2005, 60/676,124, filed Apr. 28, 2005, 60/703,925, filed Jul. 28, 2005, 60/704,681, filed Aug. 1, 2005, 60/707,577, filed Aug. 11, 2005, 60/710,368, filed Aug. 22, 2005, 60/716,869, filed Sep. 13, 2005, 60/719,469, filed Sep. 21, 2005, and 60/719,098, filed Sep. 20, 2005, to Abrams, each of which is incorporated herein by this reference), and other known carriers. The release adhesive 208 can be any suitable adhesive, such as those disclosed in any of the above copending U.S. provisional applications.

The flock 212 used in any of the processes discussed herein can be any electrostatically chargeable fiber, such as fibers made from rayon, nylon, cotton, acrylic, and polyester, with rayon and nylon being preferred. The flock fibers 212 preferably have a bright luster as opposed to a dull or semi-dull luster. As will be appreciated, the “luster” refers to the reflectance and scattering of light on the surface of the fiber. For example, nylon with a dull luster is very flat and dull looking, with a high degree of light scattering behavior. Nylon with a bright luster is shiny and sparkly, with a small degree of light scattering behavior. The light scattering ability of the flock fiber is dependent directly on the amount of light dispersants (primarily white pigment (e.g., titanium dioxide)) in the flock fiber. Fibers with higher amounts of white pigment will scatter more light than those with lower amounts of white pigment. Preferably, the flock fibers have, at most, only a small amount of the white pigment and have a low light scattering ability.

The first adhesive layer 216 may be any type of colored adhesive, such as water-based or solvent-based epoxies, phenoformaldehyde, polyvinyl butyral, cyanoacrylates, polyethylenes, isobutylenes, polyamides, polyvinyl acetate, latexes, acrylics, and polyesters, and can exhibit thermoplastic or thermoset behavior. The adhesive may be in the form of a plastisol adhesive. As will be appreciated, “plastisol” is a dispersion of finely divided resin in plasticizer. It forms a paste that solidifies when heated above a set temperature as a result of solvation of the resin particles by the plasticizer.

As can be seen from FIG. 2, the first adhesive layer has a plurality of differently colored areas which coincide, and are in registration, with the flock fibers. The first regions 228a-f have the same color as and underlie the flock fibers in the lettered areas 104a-m, and the second region 232 has the same color as and underlies the flock fibers in the background region 108.

The second and third adhesive layers can be any suitable adhesive that is preferably a substantially transparent, translucent, and clear adhesive and can exhibit thermoplastic or thermoset behavior. Examples of suitable adhesives include water-based or solvent-based epoxies, phenoformaldehyde, polyvinyl butyral, cyanoacrylates, polyethylenes, isobutylenes, polyamides, polyvinyl acetate, latexes, acrylics, and polyesters,.

The third adhesive layer 224 is preferably a thermoplastic adhesive powder, such as a powdered hot-melt adhesive. As will be appreciated, a hot-melt adhesive quickly melts upon heating and sets to a firm bond on cooling. Most other types of adhesives set by evaporation of solvent. Particularly preferred hot-melt adhesives include polyethylene, polyvinyl acetate polyamides, and hydrocarbon resins. The adhesive melts at low temperature to bond to a desired substrate.

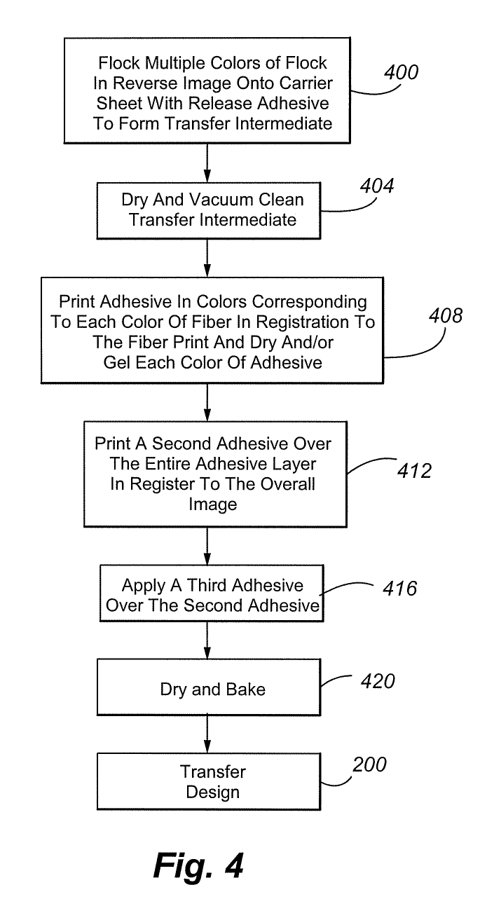

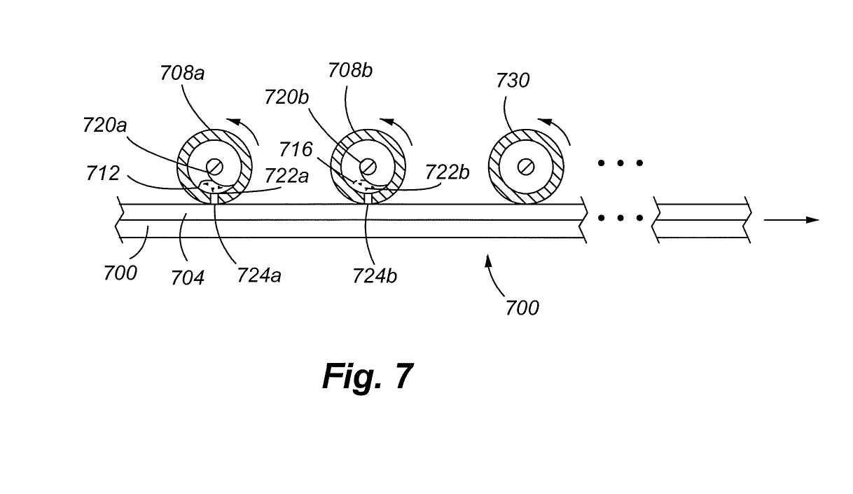

The system and process for manufacturing the article 200 will now be discussed with reference to FIGS. 4 and 7.

In step 400, a flocked transfer intermediate is formed by applying the flock fibers to a carrier sheet 204 covered with a release adhesive 208. The flock may be applied to the carrier sheet/release by a number of techniques. For example, the flock may be applied mechanically (including drop, vibration, windblown, or a combination thereof) or electrostatic techniques (including AC or DC electrostatic and air assist techniques). The intermediate is preferably formed by screen printing the release adhesive in a desired pattern (which is typically the reverse of the desired final flock pattern) on the carrier sheet followed by flocking electrostatically the carrier sheet.

In step 404, the intermediate is dried and vacuum cleaned to remove loose flock fibers.

In step 408, the first adhesive is printed onto the free ends of the flock 212 in colors corresponding to the colors of the adjacent fibers and in a pattern in registration to the fiber print. To avoid intermixing of the differently colored wet adhesives and plugging up of the printing screen, the various colored adhesives are dried and/or solidified, in whole or part, between applications. When wet adhesive is printed onto wet adhesive, the previously printed wet adhesive will stick to the bottom of the subsequent printing screen.

An apparatus for performing the printing of the adhesives is depicted in FIG. 7. Although FIG. 7 depicts a rotary printing machine, it is to be understood that any type of printing machine may be used. The apparatus includes an endless band 700 tensioned between two deflecting rollers (not shown) which move synchronously. The surface 704 to which the adhesive is applied (which in the embodiment of FIG. 2 is the flock 212 layer) faces upwards and the assembly including the surface rests on the band 700. The apparatus includes a plurality of rotatably mounted, identically radiused cylinders or motif generators 708a-b positioned above the surface 704 followed by a cylinder 730. The cylinders 708a-b and 730 define one cylinder set for depositing a selected color and pattern of (first) adhesive. The cylinders 708a-b and 730 move synchronously, and the cylinders 708a-b carry motif generators in the form of stencils. The first cylinder 708a in each cylinder set has inside of it a corresponding color of flowable liquid adhesive 712 for printing in a desired pattern on the surface 704. The second cylinder 708b has inside of it a substance 716 that forms a skin or otherwise solidifies the previously applied liquid adhesive. Stated another way, the substance is applied over and in the same pattern as the pattern of the adhesive applied by the immediately preceding cylinder 708. Thus, the first and second cylinders apply, respectively, adhesive and the substance in the same pattern in an overlapping relationship; that is, the patterns are in registration with one another.

The adhesives and substances are supplied by a stationary ducter 720 positioned in the central portion of each cylinder. During each revolution, adhesive or substance, as the case may be, comes out of a corresponding orifice 722 and screen 724. Typically in a cylinder set, the orifice 722 of the adhesive-depositing cylinder is slightly smaller than the orifice 722 of the substance-depositing cylinder so that the substance is deposited over the entire areal extent of the wet adhesive. In the cylinders, the ducter spreads out the adhesive or substance, as the case may be, over the corresponding orifice, which guides the liquid onto and through the corresponding screen and onto the surface.

The substance preferably contains a solidifying agent that causes the adhesive to solidify, in whole or part, before the next cylinder applies a next liquid adhesive of a different color. Any solidifying agent suitable for the selected adhesive chemistry may be employed. In one configuration, the substance contains a bivalent and/or trivalent metal salt on a base of magnesium and/or calcium and/or aluminum. An alginate compound has been added to the adhesive. As a result, a skin forms instantaneously on the liquid adhesive before the adhesive contacts the next cylinder 730. This skin is smooth, translucent, and transparent so that the adhesive is not disturbed. Moreover, it is thin and normally does not smear. So that the orifice of the substance-depositing cylinders does not become clogged at the edges, it is made so large that it does not touch the front and rear edge of the previously applied adhesive pattern, because otherwise the reaction between the alginate and the metal salt would clog the orifice.

The cylinder 730 is shown merely diagrammatically. It has the same structure as the other cylinders in the cylinder set. However, its orifice is angularly at another location, as there is no intent to print over the previously deposited adhesive. The adhesive is neither pressed (squeezed) into the surface by the cylinder 730 nor does it remain adhering to the circumference of the cylinder 730. To the contrary, the various (first) adhesives travel through undamaged under the cylinder 730. The (outer) skin has self-sealing properties. Even if the skin were to burst, as a result of the pressure of the cylinder 730, the small hole or crack would instantly close again, and a minimum outgrowth would occur. Enough alginate and metal salt still remains to ensure that the action can occur repeatedly without mishap. As will be appreciated, the cylinder 730 follows each substance-depositing cylinder.

When the colored adhesives are in plastisol form, the adhesives are flash cured between adhesive applications or after one color adhesive is deposited and before the next color adhesive is deposited.

In another apparatus configuration, the metal salts can be applied over the entire width of the surface 704 by means of an applicator (not shown). The remainder of the surface 704 is thereby impregnated with a layer of the metal salts. The adhesive-applying cylinders therefore deposit their respective adhesive patterns containing the alginate compound into the salt layer. The above reaction then occurs. In this apparatus configuration, the first cylinder deposits the substance over the areal extent of the first adhesive layer and the following cylinders thereafter apply the desired colors and patterns of (first) adhesives without being followed by a corresponding substance-depositing cylinder. The apparatus configuration of these configurations are discussed in GB 2 227 715 to Hechler, which is incorporated herein by this reference.

In yet another apparatus configuration, dryers are positioned between the first and third cylinders in each cylinder set. In other words, a dryer is positioned in lieu of the substance-depositing cylinder in each cylinder set. Rather than using a solidifying agent, the dryer dries or cures the adhesive before the next differently colored is applied. Generally, this configuration has much slower printing or web speeds compared to the prior two apparatus configurations using solidifying agents.

In step 412, after all of the differently colored adhesives are printed onto the corresponding fiber colors the (optional) second adhesive 220 is printed over the entire design area (or over all of the first adhesives in the first adhesive layer) and in register to the overall image. The printing of the second adhesive may be performed by known techniques.

In step 416, the third adhesive is applied to the second adhesive and, in step 420, the transfer design 200 is heated to dry and bake (or cure) the various adhesives. This desirable temperatures and residence times of this step are well known in the art.

FIG. 5 depicts a design article 500 according to another embodiment. The design article 500 differs from the transfer design of FIGS. 2-3 in that a flock adhesive layer 504 is positioned between the end of the flock and the (first) adhesive layer 216 and the carrier sheet 204 is positioned on the other side of the layer 216. The flock adhesive 504 can be any suitable liquid adhesive for binding flock fibers together, including the adhesives referenced above.

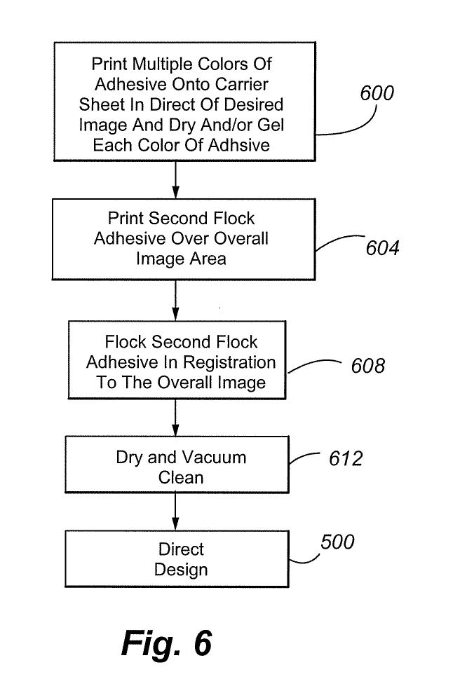

The process for manufacturing the article 500 will now be discussed with reference to FIG. 6.

In step 600, multiple colors of adhesive are printed onto the carrier sheet 204 in a direct relationship to the desired image, and each color of adhesive is dried and/or solidified. This step can be performed using the techniques and printing apparatus 700 described above.

In step 604, the second flock adhesive 504 is printed over the overall image area. Preferably, the adhesive 504 is substantially clear, translucent, and transparent so as not to detrimentally impact the viewability or viewed color of the underlying (first) adhesives.

While the flock adhesive 504 is wet and tacky, flock is flocked directly into the corresponding color of preprinted (first) adhesive. Each color of flock is flocked in a pattern in register to the correspondingly colored (first) adhesive.

In step 612, the flock adhesive and colored adhesives are dried and cured, and the loose flock fibers removed by a vacuum device.

In any of the above embodiments, artistic colors of corresponding (overlapping) colored adhesive and flock areas do not need to be precisely matching. For example, a “frosted” effect may be desired for which a light blue fiber may be backed up with a navy blue adhesive, a light green fiber with a dark green adhesive, and so forth. An important aspect of the invention is using multiple colors of fiber with coordinated multiple colors of adhesive and brilliant, shiny, clear flock fibers. This is made possible by controlling the color of the underlying adhesive.

A number of variations and modifications of the invention can be used. It would be possible to provide for some features of the invention without providing others.

For example in one alternative embodiment, the multicolored first adhesives are deposited on a carrier sheet and coated with a transparent adhesive in a first production line, a carrier sheet containing release adhesive is flocked in a second production line, and the free ends of the flock contacted with the transparent adhesive in a third production line to form a transfer having upper (top) and lower (bottom) carrier sheets. When the flock is contacted with the transparent adhesive, the flock image is in register to the corresponding adhesive image. The transparent adhesive can then be heated and cured to permanently adhere the flock to the adhesive.

In another embodiment, decorative media other than flock can be used in the article in place of the flock layer 312. For example, glitter, glass beads, metal foil, and other decorative materials may be employed.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for manufacturing a flocked article, comprising:
adhering a plurality of differently colored adhesives to a plurality of differently colored flock fibers, wherein at least some of the flock fibers have a bright luster.

2. The method of claim 1, wherein a first set of flock fibers have a first color and a second set of flock fibers have a second color and wherein a first adhesive in contact and registration with the first set has substantially the first color and a second adhesive in contact and registration with the second set has substantially the second color.

3. The method of claim 1, wherein the at least some of the flock fibers have, at most, only a small amount of white pigment and a low light scattering ability.

4. The method of claim 1, wherein a second adhesive layer is in contact with the differently colored adhesives, wherein the differently colored adhesive are positioned between the second adhesive layer and the flock fibers, and wherein the second adhesive is at least one of substantially transparent, translucent, and clear.

5. The method of claim 4, wherein a third adhesive layer is in contact with the second adhesive layer, the second adhesive layer being positioned between the differently colored adhesives and the third adhesive layer, and wherein the third adhesive layer is a thermoplastic adhesive.

6. The method of claim 5, wherein a fourth adhesive layer is positioned between the differently colored adhesives and the flock fibers.

7. An article manufactured by the method of claim 1.

8. A method of manufacturing an article, comprising:
printing a first color of adhesive onto a surface;
forming an at least substantially translucent film on the printed first colored adhesive; and
thereafter printing, in proximity to the printed first colored adhesive, a second color of adhesive, the first and second colors being different.

9. The method of claim 8, wherein the adhesive comprises an alginate compound, wherein, in the forming step, a solidifying agent is contacted with the adhesive and wherein the solidifying agent comprises a bivalent and/or trivalent metal salt on a base of a metal from Groups IA (alkali metals), IIA (alkaline earth metals), VIIB, VIIIA, IB, IIB, and IIIB of the Periodic Table of the Elements (Previous IUPAC form).

10. The method of claim 8, wherein, in the forming step, the first color of adhesive is applied by a first cylinder and the solidifying agent by a second cylinder and wherein the solidifying agent is applied over the printed first color of adhesive.

11. The method of claim 8, wherein the solidifying agent is applied to the surface before the first color of adhesive and wherein the solidifying agent substantially overlaps the first color of adhesive.

12. A flocked article manufactured by the steps of claim 8.

13. A flocked article, comprising:
a first adhesive layer comprising a plurality of differently colored adhesives; and
a plurality of differently colored flock fibers adhered to the first adhesive layer, wherein at least some of the flock fibers have a bright luster.

14. The article of claim 13, wherein a first set of flock fibers have a first color and a second set of flock fibers have a second color, wherein the first adhesive layer comprises first and second adhesives in contact, respectively, with the first and second sets of flock fibers, and wherein the first adhesive in contact and registration with the first set has substantially the first color and the second adhesive in contact and registration with the second set has substantially the second color.

15. The article of claim 13, wherein the at least some of the flock fibers have, at most, only a small amount of white pigment and a low light scattering ability.

16. The article of claim 13, wherein a second adhesive layer is in contact with the first adhesive layer, wherein the first adhesive layer is positioned between the second adhesive layer and the flock fibers, and wherein the second adhesive layer is at least one of substantially transparent, translucent, and clear.

17. The article of claim 16, wherein a third adhesive layer is in contact with the second adhesive layer, the second adhesive layer being positioned between the differently colored adhesives and the third adhesive layer, and wherein the third adhesive layer is a thermoplastic adhesive.

18. The article of claim 17, wherein a fourth adhesive layer is positioned between the differently colored adhesives and the flock fibers and wherein the fourth adhesive layer is at least one of substantially transparent, translucent, and clear.

19. The article of claim 13, wherein the first adhesive layer comprises an alginate compound.

20. The article of claim 19, wherein the adhesive comprises an alginate compound, wherein, in the forming step, a solidifying agent is contacted with the adhesive and wherein the solidifying agent comprises a bivalent and/or trivalent metal salt on a base of a metal from Groups IA (alkali metals), IIA (alkaline earth metals), VIIB, VIIIA, IB, IIB, and IIIB of the Periodic Table of the Elements (Previous IUPAC form).
